(19) United States
(12) Patent Application Publication
(10) Pub. No.: US 2012/0119541 A1
(43) Pub. Date: May 17, 2012

(54) IMPACT ENERGY ABSORBING STRUCTURE

(76) Inventor: Craig Markusic, Marysville, OH (US)

(21) Appl. No.: 12/943,965

(22) Filed: Nov. 11, 2010

(51) Int. Cl. B60R 13/02

(52) U.S. Cl. 296/187.05

(57) ABSTRACT

An impact energy absorbing structure may be attached to and detached from a finished surface of a vehicle's passenger compartment.

### I. BACKGROUND

A. Field of Invention

This invention generally relates to methods and apparatuses concerning impact energy absorbing structures used on vehicles and more specifically relates to methods and apparatuses concerning an automotive impact energy absorbing structure that can be attached and detached to the finished inner surface of a passenger compartment.

B. Description of the Related Art

It is known to construct doors and body walls that form the periphery of passenger compartments in vehicles such as automotive vehicles. Typically, the door and body wall construction includes inner panels that face the passengers within the passenger compartment and outer panels that define an outer surface of the vehicle. Decorative trim panels are commonly mounted to the inner panels of the door and body walls.

It is also known that vehicles may collide with obstacles during operation. As a result, it is known to provide vehicles with various structural upgrades and restraint systems to lessen the effects of a collision type impact on the passengers positioned within the passenger compartment. For example, some automotive vehicles may include door intrusion beams, body side structural upgrades, and/or side bolsters of foam or honeycomb construction to lessen the effects of a side collision type impact. These impact energy absorbing devices are generally positioned between the inner and outer panels.

While known impact energy absorbing devices generally work well for their intended purposes, it may be desirable to provide additional protection that is optional for the end users of the vehicle. Such additional protection may be useful, in one non-limiting example, for children.

### II. SUMMARY

According to one embodiment of this invention, an impact energy absorbing structure may include: an impact energy absorbing material that absorbs the impact energy from the associated passenger; a first side that is suitable to be attached to and detached from a finished surface of a wall of a passenger compartment of an associated vehicle; and, a second side that is suitable to receive impact energy from an associated passenger of the associated vehicle during a collision; and.

According to another embodiment of this invention, a method may include the steps of: (A) providing a vehicle having a finished surface on a wall of a passenger compartment; (B) providing an impact energy absorbing structure comprising: an impact energy absorbing material that absorbs the impact energy from the associated passenger; a first side that is suitable to be attached to and detached from a finished surface of a wall of a passenger compartment of an associated vehicle; and, a second side that is suitable to receive impact energy from an associated passenger of the associated vehicle during a collision; and, (C) attaching the first side of the impact energy absorbing structure to the finished surface of the wall.

According to yet another embodiment of this invention, a vehicle may include: a frame; at least one ground engaging wheel mounted to the frame; a body that is supported to the frame and that defines the passenger compartment; at least one door: (a) having a finished inner surface; and, (b) that is movable with respect to the body to provide access to the passenger compartment; and an impact energy absorbing structure including: (a) an impact energy absorbing material that absorbs the impact energy from the associated passenger; (b) a first side that is suitable to be attached to and detached from a finished surface of a wall of a passenger compartment of an associated vehicle; and, (c) a second side that is suitable to receive impact energy from an associated passenger of the associated vehicle during a collision.

One advantage of the present invention is that it does not require structural upgrade or modification to vehicle production tooling. The impact energy absorbing structures may be aftermarket devices and thus they will not affect the production of the existing vehicle to which they are attached.

Yet another advantage of this invention is that the impact energy absorbing structure can be easily installed to and removed from the finished surface of a wall of a passenger compartment.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective right side view of a vehicle.

FIG. 2 is a perspective right side view of a vehicle showing some of the doors in an open position.

FIG. 3 is a perspective view of a vehicle door.

FIG. 4 is a side perspective view showing an occupant positioned next to an impact energy absorbing structure.

FIG. 5 is a front perspective view of an impact energy absorbing structure.

FIG. 6 is a back perspective view of an impact energy absorbing structure.

### IV. DETAILED DESCRIPTION

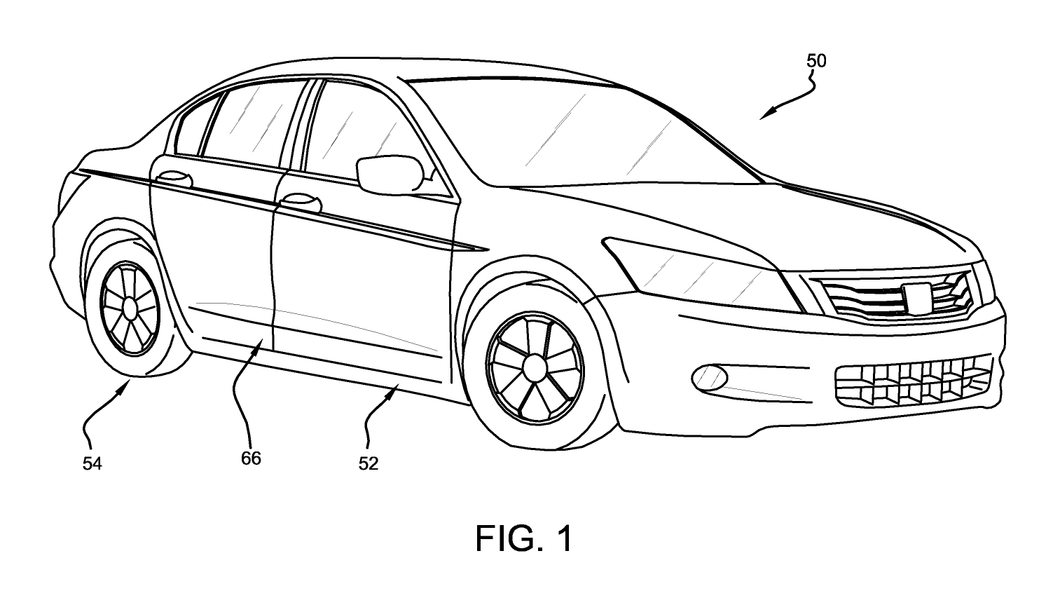

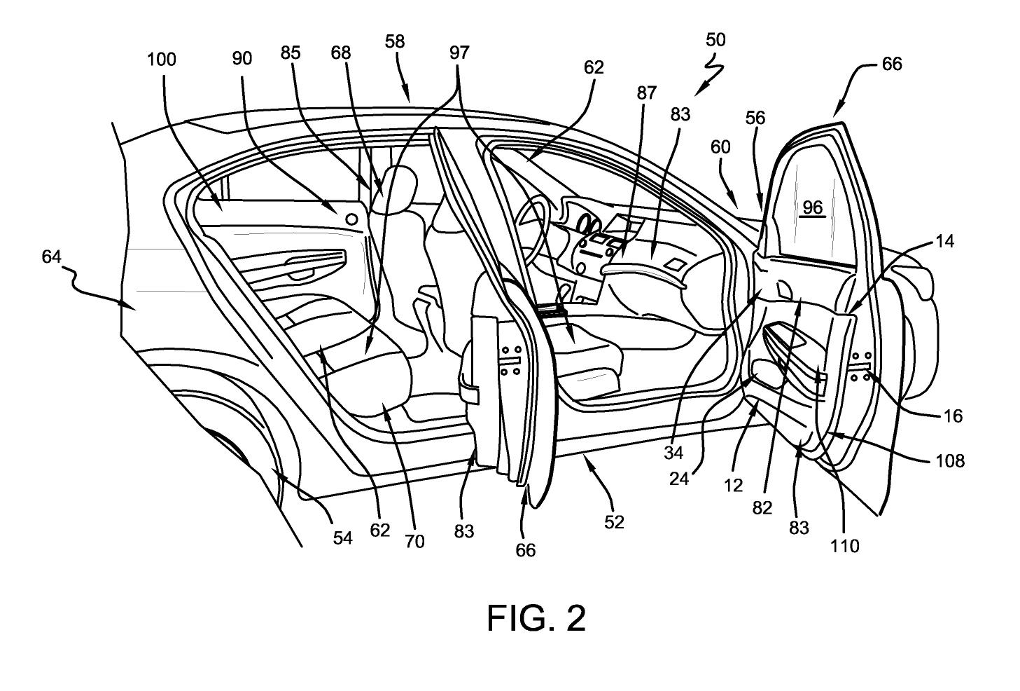

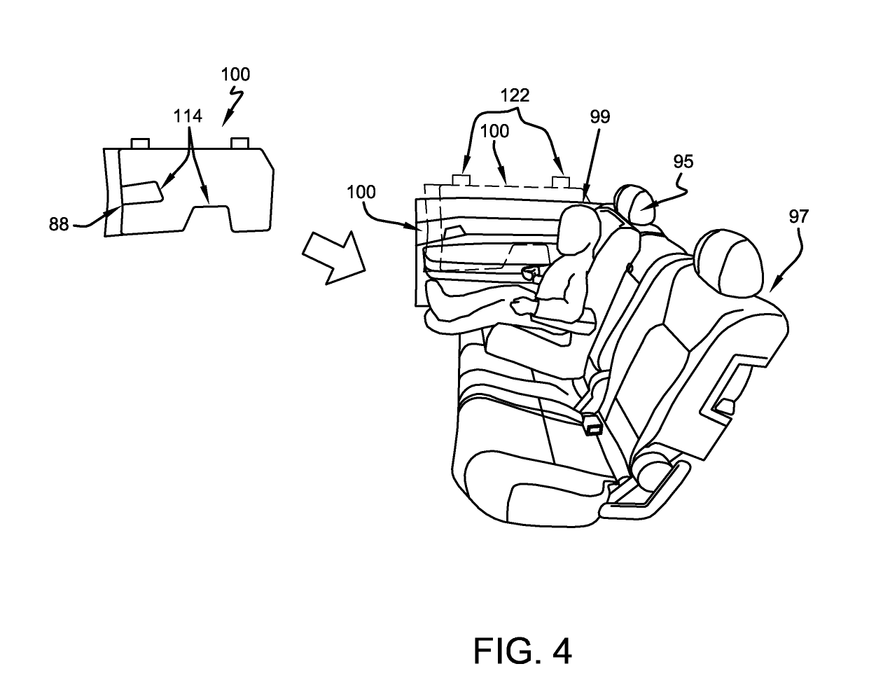

Referring now to the drawings wherein the showings are for purposes of illustrating embodiments of the invention only and not for purposes of limiting the same, and wherein like reference numerals are understood to refer to like components, FIGS. 1 and 2 show a vehicle 50 that may be equipped with one or more impact energy absorbing structures 100 (shown in FIG. 4) according to this invention. While the vehicle 50 shown is a sedan, it is to be understood that the impact energy absorbing structures 100 of this invention will work with any vehicle chosen with the sound judgment of a person of skill in the art, including SUVs, vans, busses, airplanes, and boats and may have non-vehicle applications as well. The vehicle 50 may include a frame 52, one or more ground engaging wheels 54 mounted to the frame 52, and a locomotion source 56, such as an engine or motor, mounted to the frame 52, for use in providing locomotion for the vehicle 50. The vehicle 50 may also have a body 58 mounted to the frame 52 and that defines one or more compartments. The body 58 may define, for some non-limiting examples, a locomotion compartment 60 that houses the locomotion source 56, a passenger compartment 62 that houses one or more passengers, and a storage compartment 64 that may be used to house luggage or other cargo. The vehicle 50 may also have at least one door 66 that is moveable with respect to the body 58 between an open position granting access to the interior of the body 58 (and thus may provide access to one or more of the compartments 60, 62, 64) and a closed position preventing access to the interior of the body 58.

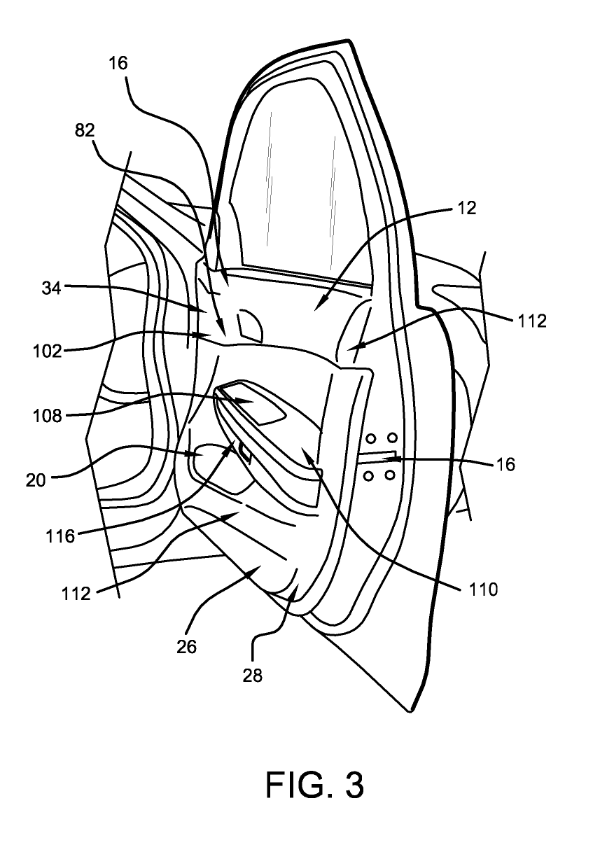

With reference now to all to FIGS. 1-4, some of the terms used throughout this patent will now be described. The word “wall,” given reference number 83 and used with reference to the passenger compartment 62, means any surface that defines a boundary of the passenger compartment 62. Some non-limiting examples of a wall thus include the inner surfaces of doors 66, the inner surfaces of posts 85 positioned between doors 66, and non-door related surfaces such as an instrument panel 87 and the inner surfaces of door-less barriers (not shown) that are common in busses and vans. The passenger compartment wall 83 may be described as having a finished surface 102. By “finished surface” it is meant that the surface is complete for full use by the end customer. Thus, all required trim panels and/or surface treatments and (such as paint, fabric, leather, and the like) must be attached to or applied onto the surface before it can be considered a finished surface. Also, all required end user implements (such as armrests, door handles, control switches, and the like) must be attached to a surface before it can be considered a finished surface. It should thus be understood that known impact energy absorbing structures are not attached to finished surfaces—they are typically attached between the inner and outer panels of a door or other vehicle wall.

With reference now to FIGS. 1-4, the passenger compartment 62 may include one or more seat assemblies 97. The seat assemblies 97 may be of any known type including bucket style seats 68, such as those shown in the front portion of the passenger compartment 62, and one or more vehicle bench seat assemblies 70. The wall or walls 83 that define the passenger compartment 62 can be of any type and style chosen with the sound judgment of a person of skill in the art. As noted above, in one embodiment a portion of the wall 83 is defined by the door 66. The door 66 can also be of any type and style chosen with the sound judgment of a person of skill in the art. In one non-limiting embodiment, the door 66 may comprises a door trim panel or substrate 12, a belt line reinforcement 14, a lock and catch assembly 16, and a window 96. The door trim panel 12 may include as attachments or integral parts thereof an armrest 108, a map pocket 24, a power switch control 116, a speaker compartment 26, and an aesthetic carpet 28. Each armrest 108 may have an armrest contact surface 110 as is well known to those of skill in the art. The lock and catch assembly 16 may include a door handle 82, a lock assembly and a catch assembly. The door inner handle 82 may be placed within a door handle housing 34 formed in the door panel 12. The power switch control 116 may be used for any known purpose such as to raise and lower the window 96. A door handle 82 may be used for any known purpose such as to be operable between latching and unlatching positions to open the door 66. As the operation of the components just described are well known to those of skill in the art, further details will not be provided here.

With reference now to FIGS. 4-6, the impact energy absorbing structure 100 may be formed of any impact energy absorbing material(s) 88 chosen with the sound judgment of a person of skill in the art. Some non-limiting examples of materials 88 that may be used include: expanded polypropylene, molded polypropylene, polyurethane, molded polypropylene, and polyurethane foam. It is also contemplated to use a transparent material to form all or a portion of the impact energy absorbing structure 100.

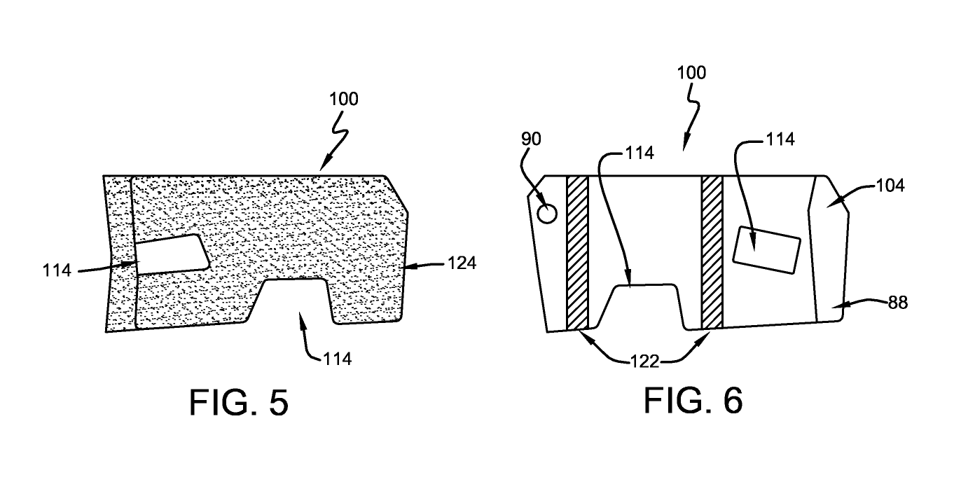

Still referring to FIGS. 4-6, the impact energy absorbing structure 100 may have a first side 104 (visible in FIG. 6) that is supported to (attached to or applied on) a finished surface 102 of the wall 83 of a passenger compartment and a second side 124 (visible in FIG. 5) that is suitable to receive impact energy from a passenger during a collision. The first side 104 may be attached to the finished surface 102 in any manner chosen with the sound judgment of a person of skill in the art. Some non-limiting examples of fasteners and methods of attachment include: one or more hook and loop fasteners 94, one or more hook and eye fasteners, one and more interlocking teeth, one or more buttons 90, one or more screws, two sided tape, and an adhesive. The impact energy absorbing structure 100 may thus have one or more attachment surfaces 122 that are used to support the impact energy absorbing structure 100 to the finished surface 102 of the door 66. In one embodiment, the impact energy absorbing structure 100 is a once piece design formed exclusively of the energy absorbing material(s) 88. In another embodiment, one or both of the sides 104, 124 may have another material added to the energy absorbing material(s) 88. In one specific embodiment, the second side 124 may be covered by a material that aesthetically matches the finished inner surface 102 of the wall 83. In yet other embodiments, various materials may be used in any orientation (such as a layered design) chosen with the skill of a person of skill in the art to form the impact energy absorbing structure 100.

Still referring to FIGS. 4-6, the impact energy absorbing structure 100 may be sized and shaped in any manner chosen with the sound judgment of a person of skill in the art. For the embodiment shown, the energy absorbing structure 100 is used to cover the portion of the finished surface of the rear door that is most likely to be encountered by an occupant 99 during a collision. In one embodiment, at least one cutout 114 (two shown) is formed in the impact energy absorbing structure 100 for use in providing access to things that would otherwise be inaccessible. For the embodiment shown, one cutout 114 (on the left as shown in FIG. 4) provides access to a handle 82 and the second cutout 114 (on the right as shown in FIG. 4) provides access to electronic switches 116 used to operate the window 96. Each cutout 114 can be of any size and shape chosen with the sound judgment of a person of skill in the art. In one embodiment, the impact energy absorbing structure 100 may cover all or a portion of the arm rest 108. In this way, the door liner profile is flattened and the chance of torso injury from armrest intrusion is reduced. The impact energy absorbing structure 100 may be positioned as shown in FIG. 4 to effectively raise the belt line. Thus reduces the chance of occupant contact with intruding objects and reduces the chance of head excursion.

With reference now to FIGS. 1-6, the operation of the impact energy absorbing structures 100 will now be described. First, a person may determine that an occupant 99 requiring an impact energy absorbing structure 100 will be positioned within the vehicle 50 juxtaposed to the finished surface 102 of the wall 83. If so, the impact energy absorbing structure 100 may then be attached to the finished surface 102 on the wall 83. If the structure 100 has one or more cutouts 114, the structure 100 is attached so that the corresponding components are accessible through the cutout 114. Once the impact energy absorbing structure 100 is installed, the occupant 99 may be placed onto a neighboring seat assembly 97. In one embodiment, shown in FIG. 4, the occupant 99 is a child that is supported in a child chair 95 that is supported to the seat assembly 97 in a known manner. Once the occupant 99 is positioned on the seat assembly 97, the various operable components of the inner panel 112, if any, can be easily accessed via the cutout 114. Once use of the vehicle is completed, if desired a person may determine that an occupant 99 requiring the impact energy absorbing structure 100 will no longer be positioned within the vehicle 50. If so, the first side 104 of the impact energy absorbing structure 100 can be easily detached from the finished surface 102 of the wall 83 and removed from the vehicle 50.

As can be seen by the above examples, the simple installation and removal procedure allows a non-technician to attach and detach the impact energy absorbing structure 100 from the wall 83 of the vehicle 50. The installation does not require a variety of tools (in some cases, no tools are required). Thus the finished surface 102 remains usable when the impact energy absorbing structure 100 is removed from the wall 83 of the vehicle 50.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. An impact energy absorbing structure comprising:
an impact energy absorbing material that absorbs the impact energy from the associated passenger;
a first side that is suitable to be attached to and detached from a finished surface of a wall of a passenger compartment of an associated vehicle; and
a second side that is suitable to receive impact energy from an associated passenger of the associated vehicle during a collision.

2. The impact energy absorbing structure of claim 1 wherein the first side is contoured to match the finished inner surface of the wall.

3. The impact energy absorbing structure of claim 1 wherein:
the finished inner surface of the wall comprises an armrest extending therefrom; and,
the impact energy absorbing structure covers the armrest to reduce the chance of torso injury to the associated passenger from the armrest.

4. The impact energy absorbing structure of claim 1 wherein:
the finished inner surface of the wall comprises a first operable component that is operable by the associated passenger; and,
the impact energy absorbing structure comprises a first cutout that permits the associated passenger to access the first operable component when the impact energy absorbing structure is attached to the finished inner surface of the wall.

5. The impact energy absorbing structure of claim 1 wherein the impact energy absorbing material comprises at least one of polyurethane and polypropylene.

6. The impact energy absorbing structure of claim 1 wherein the second side is covered by a material that aesthetically matches the finished inner surface of the wall.

7. The impact energy absorbing structure of claim 1 wherein the first side is attached to the finished inner surface of the door with an adhesive.

8. The impact energy absorbing structure of claim 1 wherein the first side of the impact energy absorbing structure is attached to the finished inner surface of the door with a hook and loop fastener.

9. A method comprising the steps of:
(A) providing a vehicle having a finished surface on a wall of a passenger compartment;
(B) providing an impact energy absorbing structure comprising: an impact energy absorbing material that absorbs the impact energy from the associated passenger; a first side that is suitable to be attached to and detached from a finished surface of a wall of a passenger compartment of an associated vehicle; and, a second side that is suitable to receive impact energy from an associated passenger of the associated vehicle during a collision; and,
(C) attaching the first side of the impact energy absorbing structure to the finished surface of the wall.

10. The method of claim 9 further comprising the step of:
(D) detaching the first side of the impact energy absorbing structure from the finished surface of the wall and removing the impact energy absorbing structure from the vehicle.

11. The method of claim 10 wherein:
prior to step (C) the method comprises the step of: determining that the associated passenger requiring the impact energy absorbing structure will be positioned within the vehicle juxtaposed to the finished surface of the wall; and,
prior to step (D) the method comprises the step of: determining that the associated passenger requiring the impact energy absorbing structure will no longer be positioned within the vehicle juxtaposed to the finished surface of the wall.

12. The method of claim 9 wherein:
step (B) comprises the step of: covering the second side of the impact energy absorbing structure with a material that aesthetically matches the finished inner surface of the door.

13. The method of claim 9 wherein step (C) comprises the step of:
using an adhesive to attach the first side of the impact energy absorbing structure to the finished surface of the wall.

14. The method of claim 9 wherein step (C) comprises the step of:
using a hook and loop fastener to attach the first side of the impact energy absorbing structure to the finished surface of the wall.

15. A vehicle comprising:
a frame;
at least one ground engaging wheel supported to the frame;
a body supported to the frame and defining a passenger compartment;
at least one door: (a) having a finished inner surface; and, (b) that is movable with respect to the body to provide access to the passenger compartment; and,
an impact energy absorbing structure comprising: (a) an impact energy absorbing material that absorbs the impact energy from the associated passenger; (b) a first side that is suitable to be attached to and detached from a finished surface of a wall of a passenger compartment of an associated vehicle; and, (c) a second side that is suitable to receive impact energy from an associated passenger of the associated vehicle during a collision; and,

16. The vehicle of claim 15 wherein the first side of the impact energy absorbing structure is contoured to match the finished inner surface of the door.

17. The vehicle of claim 16 wherein:
the finished inner surface of the door comprises an armrest extending therefrom; and,
the impact energy absorbing structure covers the armrest to reduce the chance of torso injury to the associated passenger from the armrest.

18. The vehicle of claim 17 wherein:
the finished inner surface of the door comprises a first operable component that is operable by the associated passenger; and,
the impact energy absorbing structure comprises a first cutout that permits the associated passenger to access the first operable component when the impact energy absorbing structure is attached to the finished inner surface of the door.

19. The vehicle of claim 18 wherein:
the door comprises a window and a handle that is operable to open and close the door;
the finished inner surface of the door comprises a second operable component that is operable by the associated passenger;
the impact energy absorbing structure comprises a second cutout that permits the associated passenger to access the second operable component when the impact energy absorbing structure is attached to the finished inner surface of the door;
the first operable component comprises a window control that raises and lowers the window; and,
the second operable component comprises the handle.

20. The vehicle of claim 15 wherein the impact energy absorbing material comprises at least one of polyurethane and polypropylene.
